(19) United States
(12) Patent Application Publication
(10) Pub. No.: US 2011/0186759 A1
(43) Pub. Date: Aug. 4, 2011

(54) POWER ACTUATED VALVE

(75) Inventors: Morten Kjaer Hansen, Soenderborg (DK); Benjamin Thomsen, Aabenraa (DK); Michael Tryson, Hanover, PA (US); Mohamed Benslimane, Nordborg (DK); Yousef Iskandarani, Grimstad (NO); Christopher Mose, Soenderborg (DK)

(73) Assignee: Danfoss PolyPower A/S, Nordborg (DK)

(21) Appl. No.: 12/990,333

(22) PCT Filed: Apr. 30, 2009
(86) PCT No.: PCT/DK2009/000097

§ 371 Date: Apr. 26, 2011

(30) Foreign Application Priority Data
Apr. 30, 2008 (DK) PA 2008 00621

(51) Int. Cl. F16K 31/02

(52) U.S. Cl. 251/129.01

(57) ABSTRACT

The invention provides a power actuated valve comprising a transducer and a housing which forms an inlet for entering fluid into the valve, an exit for exit of the fluid from the valve, and a path between the inlet and the exit, the transducer comprising a laminate with a film of a dielectric polymer material arranged between first and second layers of an electrically conductive material. The film is elastically deformable in response to an electrical field applied between the layers, and the transducer is arranged relative to the path so that a ratio between deformation of the film and a flow condition in the path is established.

### CROSS REFERENCE TO RELATED APPLICATIONS

This application is entitled to the benefit of and incorporates by reference essential subject matter disclosed in International Patent Application No. PCT/DK2009/000097 filed on Apr. 30, 2009 and Danish Patent Application No. PA 2008 00621 filed on Apr. 30, 2008.

### TECHNICAL FIELD

The invention relates to a valve comprising a housing forming an inlet for entering fluid into the valve, an exit for exit of the fluid from the valve, and a path between the inlet and the exit.

### BACKGROUND OF THE INVENTION

Power transducers are available for various kinds of valves used in industry. These transducers are frequently powered by electric solenoids, by hydraulics, and by pneumatics. Solenoids are simple, cheap and fairly reliable in discrete, stepwise, control of valves between different flow characteristics, typically on/off control. Pneumatic control sometimes lack sufficient strength to control large valves or valves which operate between large pressure differences. Hydraulic control is typically relatively expensive, requires inflexible pipe installations, and the presence of a liquid, and sometimes even flammable, medium is not always desirable.

The power transducers are commonly designed to mate with valves which are originally designed for manual operation. Typically, such valves include a housing with a valve member which is movable e.g. via a stem which extends from the housing. In such valves, the stem penetrates the housing, and various sealing gaskets etc are typically necessary.

### SUMMARY OF THE INVENTION

It is an object of the invention to provide an alternative to the existing power actuated valves and to facilitate valve designs which can alleviate problems with known transducers. Accordingly, the invention provides a power actuated valve with a transducer comprising a laminate with a film of a dielectric polymer material arranged between first and second layers of an electrically conductive material so that it is elastically deformable in response to an electrical field applied between the layers, wherein the transducer is arranged to provide a ratio between deformation of the film and a flow condition in the path

The laminate which is arranged to function as a transducer is relatively simple and requires in it self no mechanically interacting, rotating or sliding elements. Since an applied electrical field deforms the film elastically, the elastic property of the film provides a build-in spring-force which pushes the transducer back towards a neutral position when the electrical field disappears. Accordingly, the valve may become very reliable and cheap. Due to the build-in spring-force, use of separate spring-elements may be avoided. In addition, the laminate structure is suitable for complete integration within a valve housing, and stems or similar handles which typically extend out of the housing, may thus be avoided depending on the specifically chosen design of the valve.

By transducer is hereby meant that it is capable of converting electrical energy to mechanical energy and reciprocally of converting mechanical energy to electrical energy. This enables the use of the transducer as an actuator which works to change the flow condition through the path when provided with an electrical field between the first and second layers of electrically conductive material, and/or the use of the transducer as a sensor which provides a change of an electrical characteristic, e.g. capacitance between the layers of electrically conductive material, upon a change in the flow condition in the path.

The housing may be provided in any kind of material, e.g. in a hard polymeric material, in metal such as brass or aluminium, or even in a soft polymeric material such as silicone etc. The valve may also include micro channels and may e.g. comprise a silicon wafer, and it may in general be formed in micro scale.

By deflect is herein meant to bend or to deform under influence of a pressure. In case of the film, the deflection is triggered by the pressure from the conductive layers under a force of attraction or repulsion from an electrical field applied between the conductive layers.

By laminate is here meant a product made by two or more layers of material, e.g. bonded together. As an example, the laminate may comprise a non conductive polymer material and a conductive material on each side, where the two kinds of material are bonded e.g. adhesively, by sintering, or simply arranged in contact with each other.

In the following, an electro-active laminate is a laminate with a film of a dielectric polymer material arranged between first and second layers of an electrically conductive material so that it is elastically deformable in response to an electrical field applied between the layers.

By the specification that the transducer is arranged relative to the path to provide a ratio between deformation of the film and a flow condition in the path is meant that the transducer is functionally related to the path so that the deflection causes a change in the flow condition. As it will be described in further details later, the transducer may be arranged in the path or outside the path, and the transducer may cooperate with any kind of movable structure.

The dielectric material could be any material that can sustain an electric field without conducting an electric current, such as a material having a relative permittivity, ε, which is larger than or equal to 2. It could be a polymer, e.g. an elastomer, such as a silicone elastomer, such as a weak adhesive silicone or in general a material which has elatomer like characteristics with respect to elastic deformation. For example, Elastosil RT 625, Elastosil RT 622, Elastosil RT 601 all three from Wacker-Chemie could be used as a dielectric material.

In the present context the term ‘dielectric material’ should be interpreted in particular but not exclusively to mean a material having a relative permittivity, εᵣ, which is larger than or equal to 2.

In the case that a dielectric material which is not an elastomer is used, it should be noted that the dielectric material should have elastomer-like properties, e.g. in terms of elasticity. Thus, the dielectric material should be deformable to such an extent that the composite is capable of deflecting and thereby pushing and/or pulling due to deformations of the dielectric material.

The film and the electrically conductive layers may have a relatively uniform thickness, e.g. with a largest thickness which is less than 110 percent of an average thickness of the film, and a smallest thickness which is at least 90 percent of an average thickness of the film. Correspondingly, the first electrically conductive layer may have a largest thickness which is less than 110 percent of an average thickness of the first electrically conductive layer, and a smallest thickness which is at least 90 percent of an average thickness of the first electrically conductive layer. In absolute terms, the electrically conductive layer may have a thickness in the range of 0.01 μm to 0.1 μm, such as in the range of 0.02 μm to 0.09 μm, such as in the range of 0.05 μm to 0.07 μm. Thus, the electrically conductive layer is preferably applied to the film in a very thin layer. This facilitates good performance and facilitates that the electrically conductive layer can follow the corrugated pattern of the surface of the film upon deflection.

The film may have a thickness between 10 μm and 200 μm, such as between 20 μm and 150 μm, such as between 30 μm and 100 μm, such as between 40 μm and 80 μm. In this context, the thickness of the film is defined as the shortest distance from a point on one surface of the film to an intermediate point located halfway between a crest and a trough on a corrugated surface of the film.

The electrically conductive layer may have a resistivity which is less than 10⁻² ∩·cm or even less than 10⁻⁴ Ω·cm. By providing an electrically conductive layer having a very low resistivity the total resistance of the electrically conductive layer will not become excessive, even if a very long electrically conductive layer is used. Thereby, the response time for conversion between mechanical and electrical energy can be maintained at an acceptable level while allowing a large surface area of the composite, and thereby obtaining a large influence on the flow conditions in the path. In the prior art, it has not been possible to provide corrugated electrically conductive layers with sufficiently low electrical resistance, mainly because it was necessary to select the material for the prior art electrically conductive layer with due consideration to other properties of the material in order to provide the compliance. By the present invention it is therefore made possible to provide compliant electrically conductive layers from a material with a very low resistivity. This allows a large actuation force to be obtained while an acceptable response time of the transducer is maintained.

The electrically conductive layer may preferably be made from a metal or an electrically conductive alloy, e.g. from a metal selected from a group consisting of silver, gold and nickel. Alternatively other suitable metals or electrically conductive alloys may be chosen. Since metals and electrically conductive alloys normally have a very low resistivity, the advantages mentioned above are obtained by making the electrically conductive layer from a metal or an electrically conductive alloy.

The dielectric material may have a resistivity which is larger than 10¹⁰ Ω·cm. Preferably, the resistivity of the dielectric material is much higher than the resistivity of the electrically conductive layer, preferably at least 10¹⁴-10¹⁸ times higher.

To facilitate increased compliance of the transducer in one direction, to facilitate an improved reaction time and therefore an improved performance and controllability of the valve, or potentially to provide an increased lifetime of the transducer, the film may have a surface pattern e.g. forming corrugations which render the length of the electrically conductive layer in a lengthwise direction, longer than the length of the laminate as such in the lengthwise direction—i.e. the surface pattern makes the surface longer than the laminate as such.

The corrugated shape of the electrically conductive layer thereby facilitates that the laminate can be stretched in the lengthwise direction without having to stretch the electrically conductive layer in that direction, but merely by evening out the corrugated shape of the electrically conductive layer. If it requires a larger force to elastically deform the electrically conductive layers than that which is required to deform the film, the corrugated shaped thereby renders the laminate more compliant in that lengthwise direction than in other directions.

According to the invention, the corrugated shape of the electrically conductive layer may be a replica of the surface pattern of the film.

The corrugated pattern may comprise waves forming crests and troughs extending in one common direction, the waves defining an anisotropic characteristic facilitating movement in a direction which is perpendicular to the common direction. According to this embodiment, the crests and troughs resemble standing waves with essentially parallel wave fronts. However, the waves are not necessarily sinusoidal, but could have any suitable shape as long as crests and troughs are defined. According to this embodiment a crest (or a trough) will define substantially linear contour-lines, i.e. lines along a portion of the corrugation with equal height relative to the composite in general. This at least substantially linear line will be at least substantially parallel to similar contour lines formed by other crest and troughs, and the directions of the at least substantially linear lines define the common direction. The common direction defined in this manner has the consequence that anisotropy occurs, and that movement of the composite in a direction perpendicular to the common direction is facilitated, i.e. the composite, or at least an electrically conductive layer arranged on the corrugated surface, is compliant in a direction perpendicular to the common direction.

The variations of the raised and depressed surface portions may be relatively macroscopic and easily detected by the naked eye of a human being, and they may be the result of a deliberate act by the manufacturer. The periodic variations may include marks or imprints caused by one or more joints formed on a roller used for manufacturing the film. Alternatively or additionally, the periodic variations may occur on a substantially microscopic scale. In this case, the periodic variations may be of the order of magnitude of manufacturing tolerances of the tool, such as a roller, used during manufacture of the film. Even if it is intended and attempted to provide a perfect roller, having a perfect pattern, there will in practice always be small variations in the pattern defined by the roller due to manufacturing tolerances. Regardless of how small such variations are, they will cause periodical variations to occur on a film being produced by repeatedly using the roller. In this way the film may have two kinds of periodic variations, a first being the imprinted surface pattern of structures such as corrugations being shaped perpendicular to the film, this could be called the sub-pattern of variations, and further due to the repeated imprinting of the same roller or a negative plate for imprinting, a super-pattern arises of repeated sub-patterns.

Manufacturing the film by repeatedly using the same shape defining element, allows the film to be manufactured in any desired length, merely by using the shape defining element a number of times which results in the desired length. Thereby the size of the composite along a length direction is not limited by the dimensions of the tools used for the manufacturing process. This is very advantageous. The film may be produced and stored on a roll, and afterwards, the film may be unrolled while the electrically conductive layer or layers are applied to the film.

Each wave in the corrugated surface may define a height being a shortest distance between a crest and neighbouring troughs. In this case each wave may define a largest wave having a height of at most 110 percent of an average wave height, and/or each wave may define a smallest wave having a height of at least 90 percent of an average wave height. According to this embodiment, variations in the height of the waves are very small, i.e. a very uniform pattern is obtained

According to one embodiment, an average wave height of the waves may be between ⅓ μm and 20 μm, such as between 1 μm and 15 μm, such as between 2 μm and 10 μm, such as between 4 μm and 8 μm.

In one embodiment, the height of the waves are varying e.g. so that the height increases from a small initial height with an increasing height towards a higher end height. In this respect, the laminate may e.g. be rolled so that the wave with the initial height is in the centre of the rolled actuator or at the periphery of the rolled actuator.

Alternatively or additionally, the waves may have a wavelength defined as the shortest distance between two crests, and the ratio between an average height of the waves and an average wavelength may be between 1/30 and 2, such as between 1/20 and 1.5, such as between 1/10 and 1.

The waves may have an average wavelength in the range of 1 μm to 20 μm, such as in the range of 2 μm to 15 μm, such as in the range of 5 μm to 10 μm.

A ratio between an average height of the waves and an average thickness of the film may be between 1/50 and ½, such as between 1/40 and ⅓, such as between 1/30 and ¼, such as between 1/20 and ⅕.

The second electrically conductive layer may, like the first layer, have a surface pattern, e.g. including a corrugated shape which could be provided as a replica of a surface pattern of the film. Alternatively, the second electrically conductive layer is substantially flat. If the second electrically conductive layer is flat, the composite will only have compliance on one of its two surfaces while the second electrically conductive layer tends to prevent elongation of the other surface. This provides a composite which bends when an electrical potential is applied across the two electrically conductive layers.

One way of making the laminate is by combining several composites into a multilayer composite with a laminated structure. Each composite layer may comprise:
a film made of a dielectric material and having a front surface and rear surface, the front surface comprising a surface pattern of raised and depressed surface portions, and
a first electrically conductive layer being deposited onto the surface pattern, the electrically conductive layer having a corrugated shape which is formed by the surface pattern of the film.

In this structure, an electrode group structure may be defined, such that every second electrically conductive layer becomes an electrode of a first group and every each intermediate electrically conductive layer becomes an electrode of a second group of electrodes. A potential difference between the electrodes of the two groups will cause a deformation of the film layers located there between, and the composite is therefore electro-active. In such a layered configuration, a last layer will remain inactive. Accordingly, a multilayer composite with three layers comprises 2 active layers, a multilayer composite with 10 layers comprises 9 active layers, etc.

According to one embodiment, the raised and depressed surface portions of the surface pattern of the film of each composite layer may have a shape and/or a size which varies periodically along at least one direction of the front surface. This has already been explained above.

If the electrically conductive layers are deposited on front surfaces of the films, it may be an advantage to arrange the layers with the rear surfaces towards each other. In this way, the multilayer composite becomes less vulnerable to faults in the film. If the film in one layer has a defect which enables short circuiting of electrodes on opposite surfaces thereof, it would be very unlikely if the layer which is arranged with its rear surface against the film in question has a defect at the same location. In other words, at least one of the two films provides electrical separation of the two electrically conductive layers.

The multilayer composite can be made by a multiple layer coating technique wherein each layer is coated directly on top of the previous layer, or it can be made by “dry” lamination of finished film layers on top of each other.

The multilayer composite can be made by arranging the composite layers in a stack and by applying an electrical potential difference between each adjacent electrically conductive layer in the stack so that the layers are biased towards each other while they are simultaneously flattened out. Due to the physical or characteristic properties of the film, the above method may bond the layers together. As an alternative or in addition, the layers may be bonded by an adhesive arranged between each layer. The adhesive should preferably be selected not to dampen the compliance of the multilayer structure. Accordingly, it may be preferred to select the same material for the film and adhesive, or at least to select an adhesive with a modulus of elasticity being less than the modulus of elasticity of the film.

The composite layers in the multilayer composite should preferably be identical to ensure a homogeneous deformation of the multilayer composite throughout all layers, when an electrical field is applied. Furthermore, it may be an advantage to provide the corrugated pattern of each layer either in such a way that wave crests of one layer are adjacent to wave crests of the adjacent layer or in such a way that wave crests of one layer are adjacent to troughs of the adjacent layer.

The transducer may change the path in different ways. In one example, the valve comprises a valve element, e.g. shaped to form a ball-valve, a butterfly-valve, a gate-valve, a diaphragm-valve, a rotary-valve, a needle-valve, a pinch-valve, a spool-valve, flapper-nozzle valve, or a seat-valve. In this embodiment, the transducer may be arranged to move the valve element relative to the housing. Often, traditional valves of the above listed kind comprise a spring-force structure which pushes the valve element towards a neutral position. In this kind of valve, the transducer can be arranged to counteract the force from the spring-force structure to move the valve element away from the neutral position. Since the transducer comprises a film of an elastically deformable polymer material, the transducer itself, i.e. the film thereof, may constitute the spring-force structure and thus provide a neutral position without use of additional elements. When an electrical field is applied to the conductive layers, the film deforms against the elastic forces build into the film, and the valve moves away from neutral. When the electrical field ends, the build-in elastic property forces the valve back to the neutral position.

In an alternative embodiment, the laminate itself is arranged at least partly in the path so that deformation of the film changes the flow properties in the path, e.g. by reducing a cross sectional size of the path or by causing the path to be more or less tortuous, or by opening and closing a port or valve seat. In this embodiment, a separate valve element could be unnecessary, and the valve may become very simple in structure. In a very simple embodiment, the flow path is blocked and unblocked depending on the deformation of the film so that a flow there through is either prevented or enabled depending on the electrical field applied to the conductive layers.

The transducer may be provided so that the deformation causes a change in the volume or so that the deformation changes the shape without changing the volume. A change of volume may e.g. be obtained by including in the film, a compressible gas, e.g. regular air.

The housing can be made with various geometries. In one example, the housing forms the path and a port or seat through which the path extends. In this example, the transducer, or a separate valve element can be arranged to cover the port to a various degree in response to deformation of the film. The transducer may e.g. comprise a sealing member of a resilient material.

A larger deformation and an increased force from the transducer may be obtained by rolling the laminate to form an elongated, stick-shaped, transducer, e.g. a cylindrical transducer with a cross-sectional shape and size which is constant throughout its length, or a tubular transducer with an outer surface facing outwardly away from the transducer and an inner surface facing inwardly towards an inner conduit inside the transducer.

According to a preferred embodiment the laminate may have been rolled to form a coiled pattern of dielectric material and electrodes, the rolled laminate thereby forming the transducer. In the present context, the term ‘coiled pattern’ should be interpreted to mean that a cross section of the transducer exhibits a flat, spiral-like pattern of electrodes and dielectric material. Thus, the rolled transducer resembles a Swiss roll or part of a Swiss roll.

Traditionally, transducers based on a body of polymer between electrode layers operate with a higher performance when the polymer is pre-strained. The pre-strain can be obtained by stretching the laminate or the rolled structure obtained by rolling of the laminate by use of a spring structure. In the rolled embodiment, the transducer is preferably designed by rolling or spooling of a laminate of potentially unlimited length in a thick-walled column-like self-supporting structure. Such a self-supporting structure may become sufficiently strong to prevent buckling during normal operation of the valve. By rolling of the laminate into a rolled structure, it may be possible to avoid pre-straining of the laminate and the self-supporting structure may therefore become very simple to manufacture.

The laminate may be rolled around an axially extending axis to form a transducer of an elongated shape extending in the axial direction. The rolled laminate may form a tubular member. This should be understood in such a manner that the rolled laminate defines an outer surface and an inner surface facing a hollow interior cavity of the rolled laminate. Thus, the transducer in this case forms a ‘tube’, but the ‘tube’ may have any suitable shape.

In the case that the rolled transducer forms a tubular member, the rolled laminate may form a member of a substantially cylindrical or cylindrical-like shape. In the present context the term ‘cylindrical-like shape’ should be interpreted to mean a shape defining a longitudinal axis, and where a cross section of the member along a plane which is at least substantially perpendicular to the longitudinal axis will have a size and a shape which is at least substantially independent of the position along the longitudinal axis. Thus, according to this embodiment the cross section may have an at least substantially circular shape, thereby defining a tubular member of a substantially cylindrical shape. However, it is preferred that the cross section has a non-circular shape, such as an elliptical shape, an oval shape, a rectangular shape, or even an unsymmetrical shape. A non-circular shape is preferred because it is desired to change the cross sectional area of the transducer during operation, while maintaining an at least substantially constant circumference of the cross section. In the case that the cross section has a circular shape this is not possible, since a circular shape with a constant circumference is not able to change its area. Accordingly, a non-circular shape is preferred.

The rolled transducer may define a cross sectional area, A, being the area of the part of the cross section of the rolled transducer where the material forming the rolled transducer is positioned, and A may be within the range 10 mm² to 40000 mm², such as within the range 50 mm² to 2000 mm², such as within the range 75 mm² to 1500 mm², such as within the range 100 mm² to 1000 mm², such as within the range 200 mm² to 700 mm². Thus, A may be regarded as the size of the part of the total cross sectional area of the rolled transducer, which is ‘occupied’ by the transducer. In other words, A is the cross sectional area which is delimited on one side by the outer surface and on the other side by the inner surface facing the hollow cavity of the rolled structure.

The rolled laminate may define a radius of gyration, r_{g}, given by

$${r}_{g} = \sqrt{\frac{I}{A}} ,$$

where I is the area moment of inertia of the rolled transducer, and r_{g} may be within the range 5 mm to 100 mm, such as within the range 10 mm to 75 mm, such as within the range 25 mm to 50 mm. The radius of gyration, r_{g}, reflects a distance from a centre axis running along the longitudinal axis of the tubular member which, if the entire cross section of the rolled transducer was located at that distance from the centre axis, it would result in the same moment of inertia, I.

Furthermore, the rolled laminate may define a slenderness ratio, λ, given by λ=L/r_{g}, where L is an axial length of the rolled laminate, and λ may be smaller than 20, such as smaller than 10. Thus, the slenderness ratio, λ, reflects the ratio between the axial length of the rolled laminate and the radius defined above. Accordingly, if λ is high the axial length is large as compared to the radius, and the rolled laminate will thereby appear to be a ‘slender’ object. On the other hand, if λ is low the length is small as compared to the radius, and the rolled transducer will thereby appear to be a ‘fat’ object, hence the term ‘slenderness ratio’. An object having a low slenderness ratio tends to exhibit more stiffness than an object having a high slenderness ratio. Accordingly, in a rolled laminate having a low slenderness ratio buckling during actuation is avoided, or at least reduced considerably.

The rolled laminate may define a wall thickness, t, and the ratio t/r_{g} may be within the range 1/1000 to 2, such as within the range 1/500-1, such as within the range 1/300-2/3. This ratio reflects how thin or thick the wall defined by the rolled laminate is as compared to the total size of the rolled laminate. If the ratio is high the wall thickness is large, and the hollow cavity defined by the rolled transducer is relatively small. On the other hand, if the ratio is low the wall thickness is small, and the hollow cavity defined by the rolled laminate is relatively large.

Alternatively or additionally, the rolled laminate may have a wall thickness, t, and may comprise a number of windings, n, being in the range of 5 to 100 windings per mm wall thickness, such as in the range 10 to 50 windings per mm wall thickness. The larger this number is, the thinner the unrolled laminate has to be. A large number of windings of a thin film allows a given actuation force to be achieved with a lower potential difference between the electrodes as compared to similar transducers having a smaller number of windings of a thicker film, i.e. having the same or a similar cross sectional area. This is a great advantage.

The mechanical and electrostatic properties of an electro-active web are used as a basis to estimate actuator force per unit area and stroke. Rolled laminates as described above are made by rolling/spooling very thin composite layers, e.g. having a thickness within the micrometers range. A typical transducer of this type can be made of laminate which is wound in thousands of windings.

When activated, direct/push transducers convert electrical energy into mechanical energy. Part of this energy is stored in the form of potential energy in the transducer material and is available again for use when the transducer is discharged. The remaining part of mechanical energy is effectively available for actuation. Complete conversion of this remaining part of the mechanical energy into actuation energy is only possible if the transducer structure is reinforced against mechanical instabilities, such as well known buckling due to axial compression. This can be done by reinforcing the cross sectional area of the transducer on one hand and then optimising the length of the transducer according to Euler's theory.

The optimisation process starts by defining the level of force required for a given valve. Then based on the actuator force per unit area, it is possible to estimate the necessary cross sectional area to reach that level of force.

Stabilisation of the transducer against any mechanical instability requires reinforcing its cross section by increasing its area moment of inertia of the cross section, I. Low values of I result in less stable structures and high values of I result in very stable structures against buckling. The design parameter for reinforcing the structure is the radius of gyration

$${r}_{g} ( {r}_{g} = \sqrt{\frac{I}{A}} )$$

which relates cross section, A, and area moment of inertia, I. Low values of r_{g} result in less stable transducer structures and high values of r_{g} result in highly stable transducer structures. After having defined optimum ranges for both area, A, and radius of gyration, r_{g}, it is possible to define the optimum range for the rolled transducer wall thickness, t, with respect to r_{g} in the form of t/r_{g}. Area, A, radius, r_{g}, and wall thickness, t, are the design parameters for reinforcing the transducer cross section for maximum stability. Low values of t/r_{g} result in highly stable transducer structures and high values of t/r_{g} result in less stable transducer structures.

Once the ranges of the cross section parameters have been determined, it is necessary to estimate the maximum length, L, of the transducer, for which buckling by axial compression does not occur for the required level of force. Slenderness ratio, λ, as defined above, is the commonly used parameter in relation with Euler's theory. Low values of λ result in highly stable transducer structures and high values of λ result in less stable transducer structures against buckling.

Once all design parameters for the optimum working direct transducer have been determined, it is possible to estimate the total number of windings that are necessary to build the transducer based on the transducer wall thickness, t, and the number of windings per millimetre, n, for a given electro-active web with a specific thickness in the micrometer range.

The rolled transducer may comprise a centre rod arranged in such a manner that the transducer is rolled around the centre rod, the centre rod having a modulus of elasticity which is lower than a modulus of elasticity of the dielectric material. According to this embodiment the hollow cavity defined by the tubular member may be filled by the centre rod, or the centre rod may be hollow, i.e. it may have a tubular structure. The centre rod may support the rolled transducer. However, it is important that the modulus of elasticity of the centre rod is lower than the modulus of elasticity of the dielectric material in order to prevent that the centre rod inhibits the function of the transducer.

Alternatively or additionally, the rolled transducer may comprise a centre rod arranged in such a manner that the transducer is rolled around the centre rod, and the centre rod may have an outer surface abutting the rolled transducer, said outer surface having a friction which allows the rolled transducer to slide along said outer surface during actuation of the transducer. The centre rod could, in this case, e.g. be a spring or similar elastically deformable element. Since the rolled transducer is allowed to slide along the outer surface of the centre rod, the presence of the centre rod will not inhibit elongation of the transducer along a longitudinal direction defined by the centre rod, and the operation of the transducer will thereby not be inhibited by the presence of the centre rod due to the low friction characteristics of the centre rod.

The transducer which comprises a rolled laminate may have an area moment of inertia of the cross section which is at least 50 times an area moment of inertia of the cross section of an un-rolled transducer, such as at least 75 times, such as at least 100 times. According to the present invention, this increased area moment of inertia is preferably obtained by rolling the transducer with a sufficient number of windings to achieve the desired area moment of inertia of the rolled structure. Thus, even though the unrolled transducer is preferably very thin, and therefore must be expected to have a very low area moment of inertia, a desired area moment of inertia of the rolled transducer can be obtained simply by rolling the transducer with a sufficient number of windings. The area moment of inertia of the rolled transducer should preferably be sufficient to prevent buckling of the transducer during normal operation.

Thus, the rolled transducer may have a number of windings sufficient to achieve an area moment of inertia of the cross section of the rolled transducer which is at least 50 times an average of an area moment of inertia of the cross section of an un-rolled transducer, such as at least 75 times, such as at least 100 times.

According to one embodiment, positive and negative electrodes may be arranged on the same surface of the dielectric material in a pattern, and the transducer may be formed by rolling the dielectric material having the electrodes arranged thereon in such a manner that the rolled transducer defines layers where, in each layer, a positive electrode is arranged opposite a negative electrode with dielectric material there between. According to this embodiment the transducer may preferably be manufactured by providing a long film of dielectric material and depositing the electrodes on one surface of the film. The electrodes may, e.g., be arranged in an alternating manner along a longitudinal direction of the long film. The long film may then be rolled in such a manner that a part of the film having a positive electrode positioned thereon will be arranged adjacent to a part of the film belonging to an immediately previous winding and having a negative electrode thereon. Thereby the positive and the negative electrodes will be arranged opposite each other with a part of the dielectric film there between. Accordingly, a transducer is formed when the film is rolled.

The laminate may e.g. be rolled relative to a surface pattern of at least one of the layers so that the deformation of the film causes radial expansion of the transducer. This could be obtained with a pattern of corrugations extending parallel to an axis around which the laminate is rolled. Alternatively, the laminate could be rolled relative to a surface pattern of at least one of the layers so that the deformation of the film causes axial expansion of the transducer and thus variable distance between axially opposite end faces of the transducer. This could be obtained with a pattern of corrugations extending perpendicularly to the axis around which the laminate is rolled so that the crests and chests of the corrugations extend circumferentially around the transducer.

One of the end faces could comprise a sealing member which is shaped to cooperate with the previously mentioned port or seat of the housing. The sealing member may e.g. be an o-ring arranged in a recess in one of the end faces.

If the transducer is tubular, the housing may comprise a tubular outer element forming a conduit, and an inner element arranged in the conduit. The tubular shaped transducer could be arranged between an inner surface of the outer element and an outer surface of the inner element. An outer surface of the tubular transducer could be sealed to the inner surface of the outer element and an inner surface of the tubular transducer could be sealed to the outer surface of the inner element so that a fluid would be prevented from passing between the outer element and the transducer and also be prevented from passing between the inner element and the transducer. To establish a flow through the valve, the inner element could also be tubular or at least hollow, and it may be provided with at least one passage from an opening in the outer surface of the inner element to an opening in an inner surface of the inner element. The transducer could thus be arranged so that it selectively covers the opening and uncovers the opening when the film is deformed. The transducer may also constitute at least a part of the inner element. As an example, the transducer may itself be tubular with a number of openings through the laminate so that a fluid can flow from outside the tubular transducer and into the inner conduit in the tubular transducer. In this embodiment, the inner conduit may house a closing-element around which the transducer may squeeze when the film is deformed, and the openings through the wall of the transducer may thus be blocked by the closing-element.

### BRIEF DESCRIPTION OF THE DRAWINGS

In the following, different embodiments of the invention will be described in further details with reference to the drawing in which:

FIGS. 1 and 2 illustrate a valve according to the invention in an open and a closed configuration;

FIG. 3 illustrates a laminate for a transducer;

FIGS. 4 and 5 illustrate rolling of the laminate for elongation and expansion, respectively;

FIG. 6 illustrates an alternative way of making a rolled transducer by stacking of two composite structures;

FIGS. 7-31 illustrate various alternative valves;

FIG. 32 illustrates an electrical diagram of a control system for controlling the valves;

FIG. 33 illustrates in a diagram a ratio between capacitance of the transducer and deflection of the film; and

FIG. 34 illustrates in different diagrams each being for a specific pressure, a ratio between a bias voltage and a deflection of the film.

### DETAILED DESCRIPTION OF THE PREFERRED EMBODIMENTS

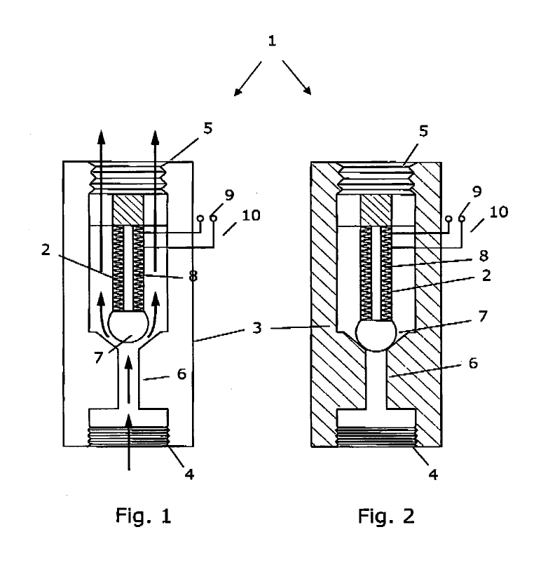

As illustrated in FIG. 1, the valve 1, comprises a transducer 2 arranged in a housing 3 which forms an inlet 4 for entering fluid into the valve, and an exit 5 for exit of the fluid from the valve. A path 6 extends between the inlet and the exit, and a valve member 7 is arranged to control flow conditions in the path. The valve member 7 is moved by the transducer 2.

The transducer is made from a laminate with a film of a dielectric polymer material arranged between first and second layers of an electrically conductive material so that it is elastically deformable in response to an electrical field applied between the layers. The laminate is rolled and therefore has a tubular shape with wall around an inner cavity 8.

First and second connectors 9, 10 are provided to apply the electrical field to the layers.

A fluid flow through the valve is symbolized by the bolded arrows in FIG. 1, and the deformation of the dielectric polymer material influences the flow conditions by changing the area of the passage between the inner wall of the housing 3 and the valve member 7.

The valve opens and closes by movement of the valve member 7 in the direction of the path 6. This is enabled in a very simple manner by arrangement of the transducer inside the path, and this is possible due to the very simple and robust structure of the transducer.

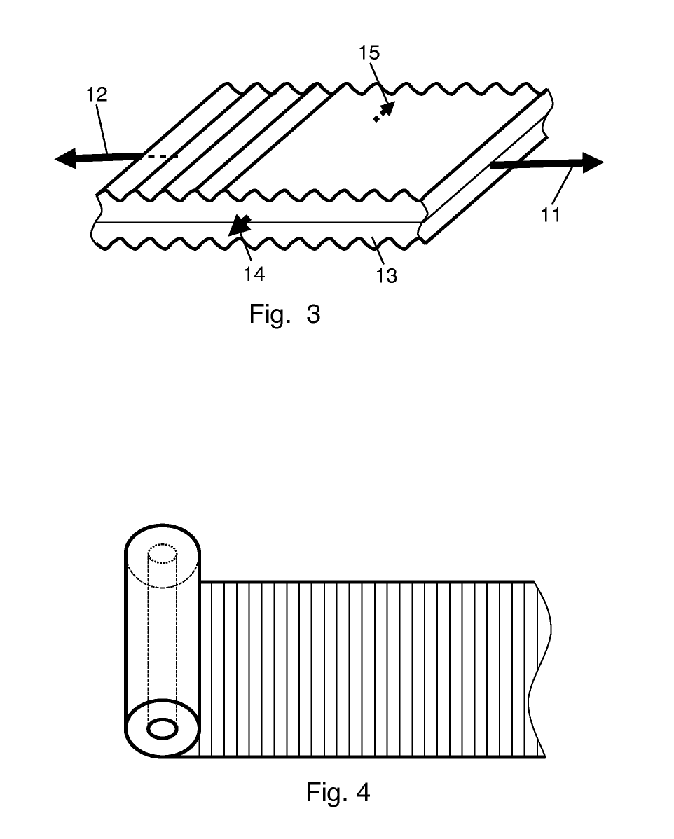

The laminate is provided so that it is easier to deform in one, compliant, direction than in other directions. The laminate is further provided with an anisotropic characteristic so that it is less compliant in one specific direction than in other directions. As illustrated in FIG. 3, this characteristic can be provided by a waved surface structure by which the laminate can be expanded in the compliant, longitudinal, direction indicated by the bold arrows 11, 12 by elastic deformation of the polymer material 13, while the electrically conductive material which is applied to the waved surface is straightened out rather than stretched.

By selection of a conductive material which requires a larger force to deform elastically than that required to deform the polymer material, and by application of the conductive material throughout the transverse direction indicated by the bold arrows 14, 15, i.e. parallel to the direction in which the crests and troughs of the waves extend, the laminate becomes anisotropic. By anisotropic is meant that the laminate is compliant in the longitudinal direction and non-compliant in the transverse direction.

The laminate structure illustrated in FIG. 3 is rolled to form a tubular actuator. The laminate may be rolled around an axis extending in parallel with the crests and troughs as shown in FIG. 4. This provides radial expansion of the tubular actuator upon deformation of the polymer—herein referred to as “rolled for expansion”. The laminate may also be rolled around an axis being perpendicular to the crests and troughs as shown in FIG. 5. This provides axial elongation of the tubular actuator upon deformation of the polymer—herein referred to as “rolled for elongation”. When the laminate is rolled, the two opposite layers of a conductive material, in the following referred to as the top and bottom layer, must be electrically separated from each other by an additional film of a non conductive material.

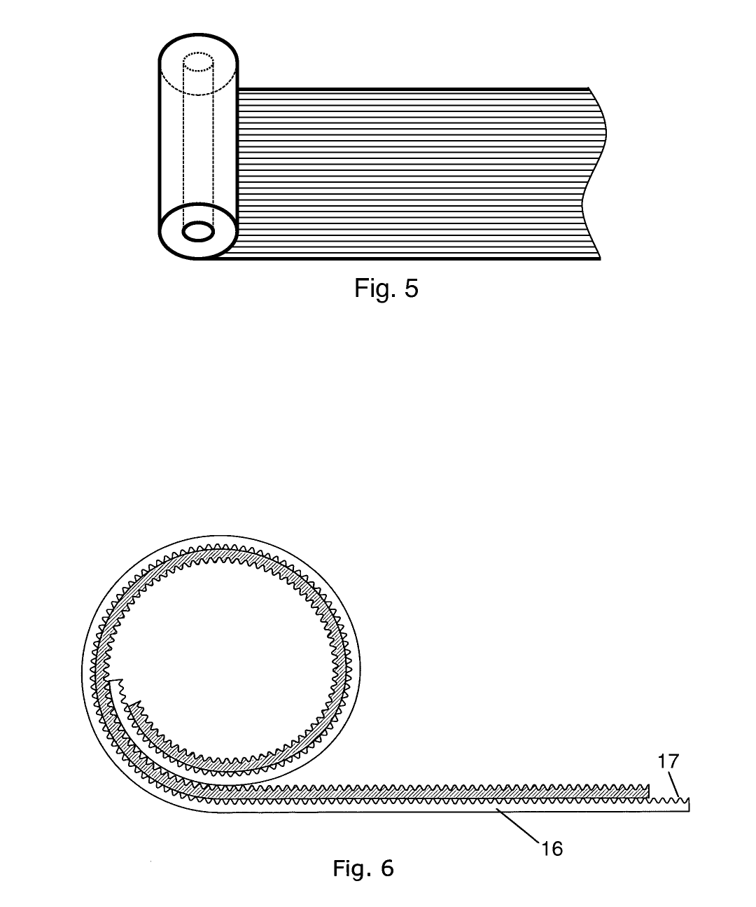

FIG. 6 illustrates a laminate which is rolled to form a tubular structure and which comprises a multilayer structure with at least two composites. The composites are identical and each comprises a film 16 made of a dielectric polymer material and having a front surface and a rear surface, the front surface comprising a surface pattern of raised and depressed surface portions, and a first layer 17 of an electrically conductive material being deposited onto the surface pattern. When such two composites are arranged on top of each other, a laminate with a film of a polymer material between two electrically conductive layers is formed. The second film provides isolation between the top and bottom layers.

The transducer in FIG. 1 is rolled for elongation, and an electrical field applied between the two connectors 9, 10 therefore results in a change of the length of the transducer and thus a change of the distance between the valve member 7 and the inner surface of the housing 3. Accordingly, the illustrated valve provides a ratio between deformation of the film and a flow condition, namely a flow resistance, in the path.

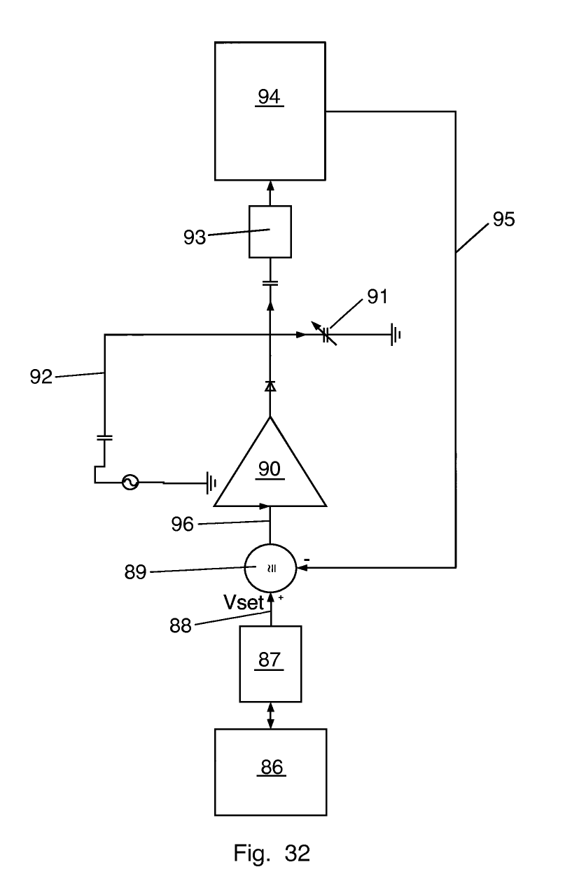

In addition to the use of the transducer for controlling the flow through the valve, the transducer may also be used for determining pressure of a fluid flowing in the valve and thus, for a known flow system, for determining flow speed etc. for the system in question. This will be described in further details with reference to FIG. 32 illustrating an electrical diagram of a control system for controlling operation of the transducer in FIG. 1.

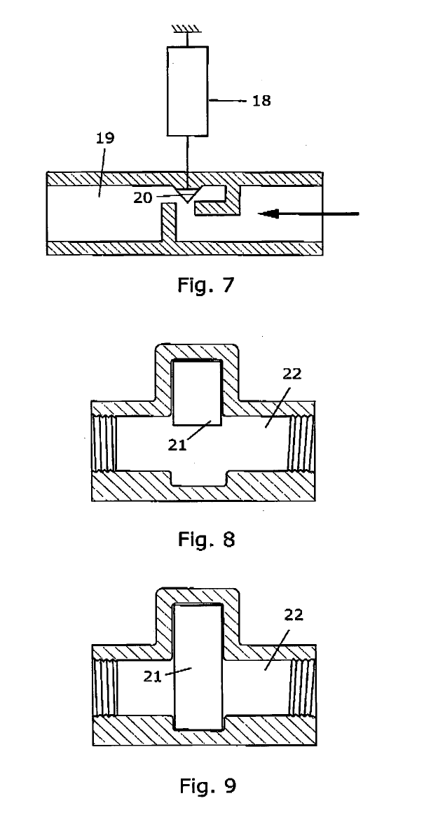

FIG. 7 illustrates a first alternative embodiment of the valve illustrated in FIG. 1. The transducer 18 is rolled for elongation, and in this embodiment, the transducer is arranged perpendicularly to the path 19 and outside the path. The transducer 18 moves a valve element 20 and thereby forms a sliding valve.

FIGS. 8 and 9 illustrate a second alternative embodiment with a transducer 21 which is rolled for elongation. The transducer is arranged perpendicularly to the path 22 inside the path and it influences the passage directly by itself. In FIG. 8, the valve is open, and in FIG. 9, the valve is closed.

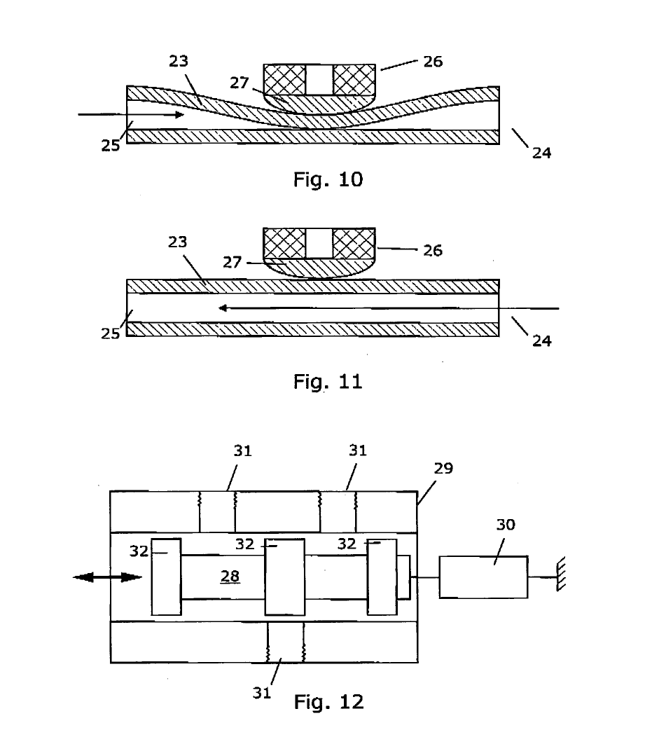

FIGS. 10 and 11 illustrate a third alternative embodiment of a valve comprising a hose 23 made from an elastically deformable material, e.g. a medical hose. The hose 23 constitutes at least a part of the housing and forms an inlet 24 for entering fluid into the valve and an exit 25 for exit of the fluid from the valve. Flow conditions in the path between the inlet and the exit can be changed by actuation of the transducer 26 which is arranged to pinch the hose. In the illustrated embodiment, the transducer 26 is rolled for elongation, and it is arranged to move a pinch element 27 made from a material which requires a larger force to deform elastically than what is required to deform the hose 23.

FIG. 12 illustrates a fourth alternative embodiment of a valve with a spool 28 being moveable in the sleeve 29. The spool is moved by a transducer 30 which is rolled for elongation. The spool valve may have any number of ports 31 and corresponding valve elements 32 fixed to the spool 28.

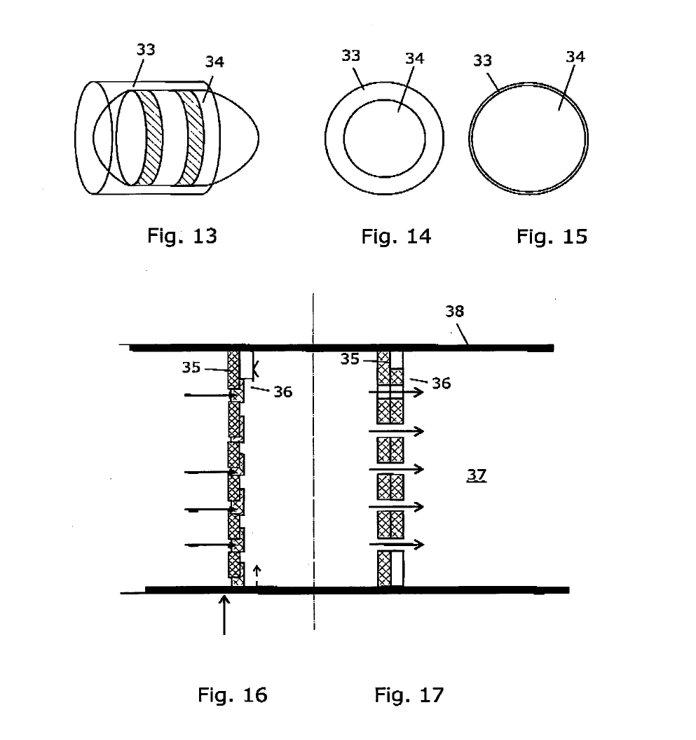

FIGS. 13-15 illustrate a fifth alternative embodiment of the valve. In this case, the valve comprises a housing 33 forming a cylindrical chamber, and a plug-shaped transducer 34 which is rolled for expansion. The transducer is arranged in the chamber. FIG. 13 illustrates a side view of the valve and FIGS. 14-15 illustrate top views of the valve. In FIGS. 13 and 15 the transducer is in an expanded state in which an outer surface of the transducer is pressed against an inner surface of the cylindrical chamber and the transducer thereby prevents passage of a fluid through the chamber. FIG. 14 illustrates the transducer in an un-expanded state in which there is a space between the outer surface of the transducer and the inner surface of the chamber.

FIGS. 16-17 illustrate a sixth embodiment of the valve in which two elements 35, 36, e.g. circular disk shaped elements, are arranged directly against each other in a flow path 37 in a housing 38. A transducer is arranged to move the elements relative to each other between a position where holes in the elements are in line with each other and a position where the holes are offset relative to each other and passage therefore is prevented.

In the sixth embodiment, one of the elements 35 or both of the elements 35, 36 could be made directly from an electro-active laminate. When the polymer deflects, holes in the laminate 35 are shifted slightly which brings the holes out of line with holes in the other element 36.

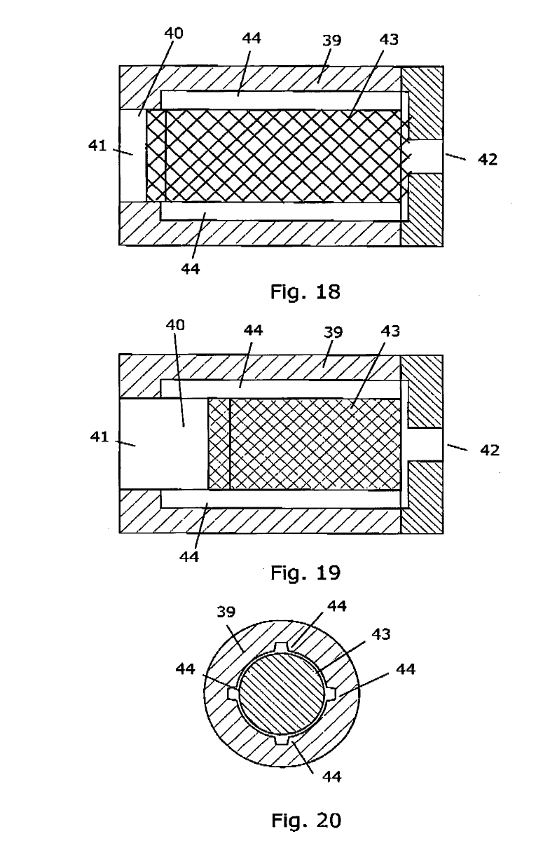

FIGS. 18-20 illustrate a seventh alternative embodiment of the valve with a housing 39 with a cylindrical chamber 40, an inlet 41, and an exit 42. The transducer 43 is rolled for elongation and has a cross-sectional size and shape which matches the cylindrical shape of the chamber 40 so that a fluid flow between the outer surface of the transducer and inner surface of the chamber is prevented. The inner surface of the chamber is, however, provided with a number of grooves 44 so that fluid passage across the transducer is possible in the grooves 44. In the elongated state, c.f. FIG. 18, the length of the transducer 43 prevents access to the grooves and thus fluid passage from the inlet to the outlet. In the non-elongated state, c.f. FIG. 19, the grooves are accessible and fluid passage thus obtainable. The grooves may extend over a certain portion of the inner surface so that they begin and end at a certain distance from the opposite ends of the chamber. In this embodiment, the transducer may serve both to prevent entrance of fluid into the grooves and exit of fluid out of the grooves. In this case, the transducer may be fixed in the chamber so that elongation and contraction provides movement of both of the axially opposite end faces relative to the inner surface of the chamber. They may also begin at a certain distance from one of either the inlet or outlet and extend all the way through the chamber so that the transducer merely prevents entrance or exit of fluid into or out of the grooves. The grooves may have a constant cross-sectional shape and size, or they may change shape and size, e.g. by fading out in the inner surface to provide a specific opening or closing characteristic when the end face of the transducer moves over the grooves. In one embodiment, the inner surface is provided with several grooves which fade out at different locations in the inner surface. FIG. 20 shows a cross section of the valve perpendicular to the flow direction.

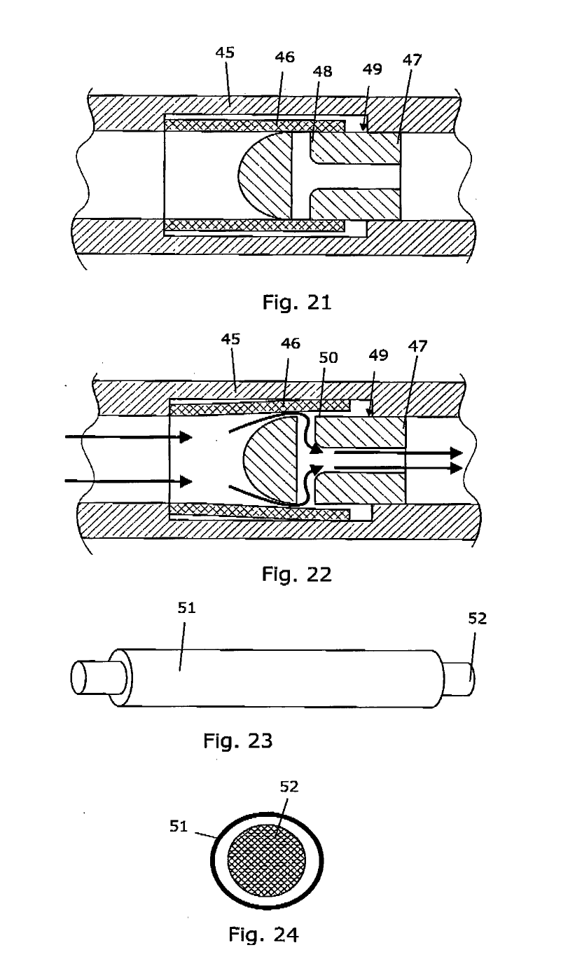

FIGS. 21-22 illustrate an eighths alternative embodiment of the valve with a valve housing 45 and a transducer 46 which is rolled for expansion. The transducer 46 is arranged partly around a centre element 47 and blocks a passage 48 through that centre element when it is radially contracted onto an outer surface 49 of the centre element 47. When the transducer 46 expands, c.f. FIG. 22, the openings 50 in the outer surface 49 of the centre element 47 become uncovered and a flow through the valve is enabled. The flow is illustrated with bold arrows.

FIGS. 23-24 illustrate a ninths embodiment of the valve comprising an electro-active laminate 51 which is rolled for expansion. The laminate is rolled to form a transducer with a tubular shape and having an inner conduit which enables the transducer itself to form the flow path. When the transducer is expanded, the cross-sectional area of the flow path increases in size and when the transducer contracts, it decreases in size. A solid core 52 can be arranged in the conduit to facilitate complete closing of the passage when the transducer contracts onto the core. The core 52 could be a bendable wire, e.g. made from rubber, nylon etc. whereby the entire valve may become soft and bendable. FIG. 24 illustrates the valve in a top view.

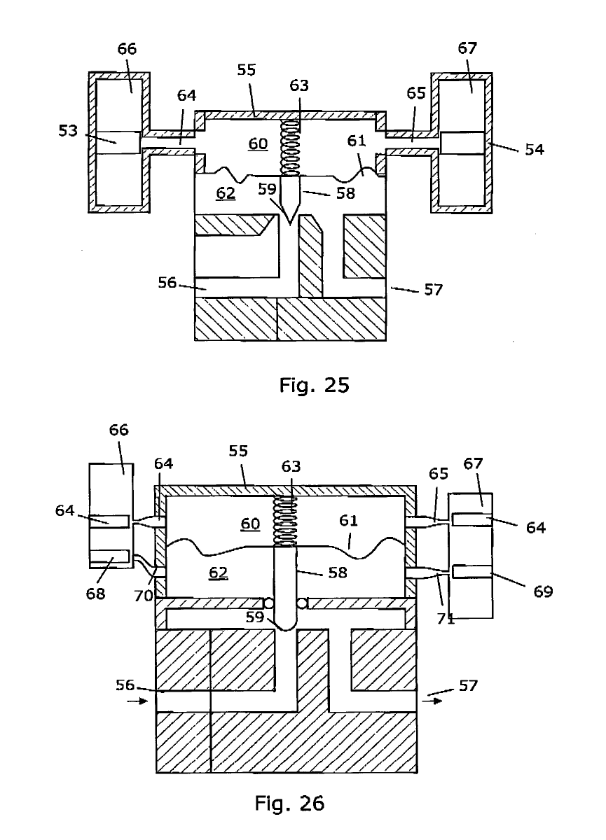

FIGS. 25 and 26 illustrate servo valves with two transducers 53, 54 made from an electro-active laminate rolled for elongation. The valves comprise a valve house 55 forming an inlet 56 and an exit 57. A valve member 58 is movable relative to a valve seat 59 to control a flow of a fluid through the housing. The valve member 58 is moved relative to the valve seat 59 by a differential pressure between an upper chamber 60 on an upper side of a membrane 61 and a lower chamber 62 below the membrane 61. To adjust the characteristic of the valve, one or more spring force providing elements 63 may be arranged in the house 55.

In FIG. 25, the differential pressure over the membrane is controlled by adjusting the passages 64, 65 between the upper chamber 60 and high and low pressure chambers 66, 67, respectively.

In FIG. 26, the differential pressure over the membrane is controlled by adjusting the passages between the high and low pressure chambers 66, 67 and the upper and lower chambers 60, 62. For this purpose, the valve comprises additionally two actuators 68, 69 which are rolled for elongation and which controls flow in the passages 70, 71.

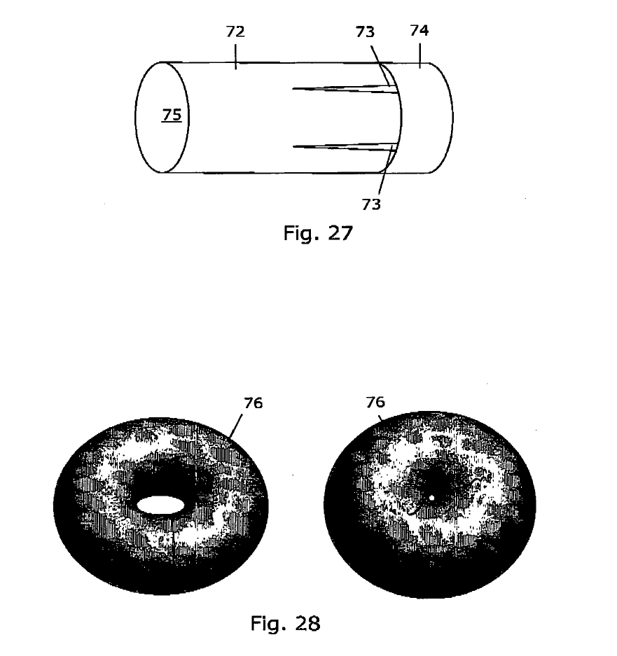

FIG. 27 illustrates a valve comprising a tubular element 72 with at least one axial slot 73. The transducer 74 of the valve comprises an electro-active laminate which is rolled for expansion, and which is arranged in the inner conduit 75 of the tubular element 72. Upon expansion of the transducer, the tubular element 72 expands whereby the slot 73 opens.

FIG. 28 illustrates a transducer 76 made from an electro-active laminate which is rolled for elongation and where the ends are joined to form a torus. Upon elongation or contraction of the roll, the size of the opening through the torus changes, and the transducer therefore enables fluid control in a valve.

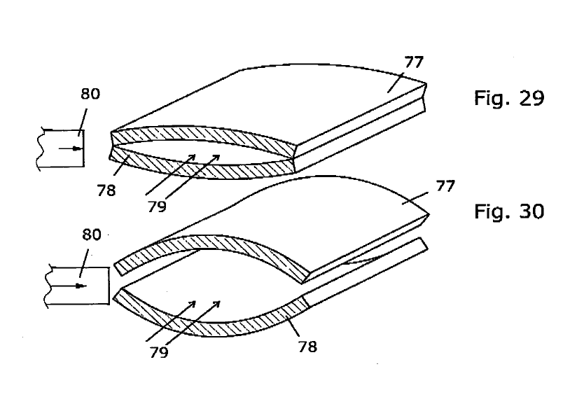

FIGS. 29 and 30 illustrate a valve made up from two flat springs 77, 78 arranged towards each other to form there between, a conduit 79 with a size which can be varied by deflection of the springs. A transducer 80 which is rolled for elongation is arranged to deflect the springs.

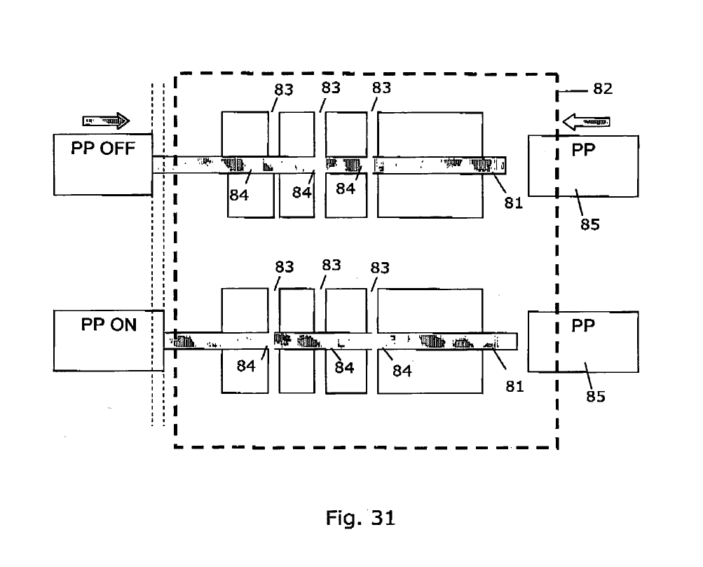

FIG. 31 illustrates a manifold valve with a rod 81 which is movable in a housing 82. The housing comprises a plurality of channels 83. When a hole 84 in the rod is in line with one of the channels 83 in the housing 82, the corresponding passage through the channel and hole is open. Oppositely, the channels are blocked by the rod when the holes of the rod are not in line with the channels. The rod 81 is moved by a transducer 85 with an electro-active laminate, e.g. a transducer rolled for elongation.

FIG. 32 illustrates an electrical diagram of a control system with a closed control loop which a ratio between capacitance and orifice effective flow area forms a reference characteristic for the valve in a specific situation, e.g. for a valve which is not subjected to a fluid pressure.

The control system is capable of applying a known bias voltage between the layers and simultaneously to determine the capacitance of the laminate. According to the reference characteristic for the valve, the applied bias voltage should provide a theoretical orifice effective flow area and thus a theoretical capacitance of the laminate. By the simultaneous measurement of the capacitance, the control system is capable of deriving an actually obtained orifice effective flow area and to adjust the bias voltage until a desired flow area is obtained.

The control system comprises data storage capacity 86 in which a ratio between an orifice effective flow area versus actuator capacitance is specified. In a most simple embodiment, the ratio is stored as discrete values. A computing device 87 communicates with the data storage 86 and determines based on a desired orifice area, a theoretical bias voltage 88 by which the film is theoretically deflected to cause the desired orifice area. The computing device communicates the theoretical bias voltage to an error correction device 89 from which the bias source 90 receives input for setting a high voltage bias signal to the actuating device 91. The actuating device 91 comprises a laminate of the kind already described, and in the diagram, such a laminate corresponds to a capacitor.

In addition to the bias signal, the bias source 90 provides, via the connection 92, a low voltage test signal which is applied to the laminate simultaneously with the bias signal. The filter 93 extracts the low voltage signal from the high voltage signal, and the capacitance measuring device 94 determines the actual capacitance of the laminate actuating device 91.

The capacitance is determined while the film is deflected by the high voltage bias signal and therefore, the capacitance indicates how much the film was deflected by the bias signal. In the illustrated embodiment, the capacitance is converted into feedback signal 95, in this case in form of a comparative bias voltage, i.e. a bias voltage which, with the reference characteristics of the valve, would have provided that deflection of the film which actually occurred and which was determined by measuring of the capacitance. The comparative bias voltage is subtracted from the determined bias voltage in the correction device 89 and the resulting corrected bias voltage 96 is received by the bias source 90.

In general, the feedback signal 95 can be manipulated in various ways via amplifies and converters of different kind.

The capacitance measuring device may also be implemented in a regular computer system, and it may include, without being limited to, any of the following measuring principles: AC Power, AC Voltage, RMS Power, Peak detectors, Log detectors, RSSI, Impedance, Pulse Measuring circuit or Spectral Measuring circuit.

The setting voltage that provides the high voltage bias signal to the actuator is typically greater than 300 Volts and less than 10 kV. An example would be 500 to 2.5 kV high voltage. The Low voltage test signal would typically be between 1 and 10 V, an example would be 3 to 5V. The High voltage actuator control signal is typically DC to low frequency less than 1 KHz repetition rate, an example would be 50 Hz. The AC test signal is generally at a frequency rate considerably higher than the actuator, usually by a factor of 10 away from the actuator repetition rate. An actuator with a 2.5 kV signal, with a 10 Hz repetition rate, could have an AC test signal of 5V and 1 KHz repetition rate.

The data processing structure may further be adapted to use the determined area of the orifice to provide flow specific information. Such information may be based on information in a second data file which describes a ratio between the area of the orifice and pressure drop over the valve, flow speed for a specific fluid etc.

Furthermore, the control system may be adapted to control the valve for dosing purposes. As an example, the control system may be capable of reading a user request with respect to the flow. As an example, this may be a desired pressure drop, a desired flow speed, or a desired dose of a fluid medium which is released through the valve. Based on the request, the control system controls applies a bias voltage to the first and second electrically conductive layers while the capacitance is measured. In this way the area of the orifice is determined and by use of the data in the first and second data files, the request may be fulfilled.

FIG. 33 shows a graph which illustrates a ratio between deflection of the film and thus the size of the aperture along the X-axis and capacitance of the transducer along the Y-axis. The graph is for illustrative purpose only, and the exact ratio depends on details of the transducer.

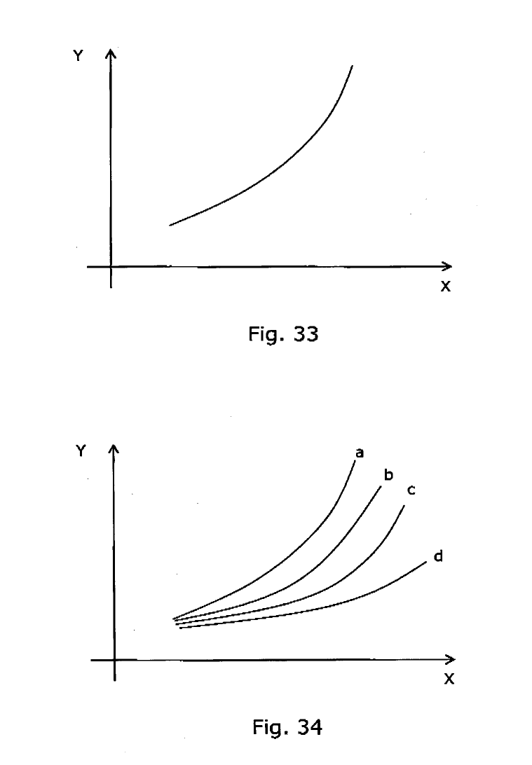

FIG. 34 shows 4 graphs illustrating four different ratios between bias voltage along the X-axis and deflection of the film along the Y-axis. The graph illustrates the ratio for an unloaded transducer—i.e. a transducer in a situation with no pressure difference across the valve. Graph b illustrates the ratio for a relatively small load, graph c for a larger load, and graph d for an even larger load applied to the transducer.

The graphs in FIGS. 33 and 34, and thus the information necessary to control the valve may be determined experimentally by various tests where a bias voltage is applied to a transducer which is loaded by different pressures. The graphs may also be found analytically by simulation flow conditions etc. for a valve. The graphs may represent discrete values of deflection to capacitance or bias voltage to deflection, or a control function may be formed which provides a continuous ratio between the values in question.

For control of the valve, the control system may derive from the measured capacitance, a specific deflection of the film. From the known bias voltage and the specific deflection, the control system may determine which load and thus pressure which is applied on the valve. By use of a model of the flow and pressure conditions for a valve which operate on a specific fluid, the control system may further provide specific flow data such as a flow rate etc.

While the present invention has been illustrated and described with respect to a particular embodiment thereof, it should be appreciated by those of ordinary skill in the art that various modifications to this invention may be made without departing from the spirit and scope of the present.

What is claimed is:

1. A power actuated valve comprising a transducer and a housing which forms an inlet for entering fluid into the valve, an exit for exit of the fluid from the valve, and a path between the inlet and the exit, the transducer comprising a laminate with a film of a dielectric polymer material arranged between first and second layers of an electrically conductive material so that it is elastically deformable in response to an electrical field applied between the layers, wherein the transducer is arranged relative to the path to provide a ratio between deformation of the film and a flow condition in the path.

2. The valve according to claim 1, wherein the film has a first surface and an opposite second surface, at least the first surface comprising a surface pattern of raised and depressed surface portions.

3. The valve according to claim 2, wherein the first electrically conductive layer is deposited onto the surface pattern and has a shape of raised and depressed surface portions which is formed by the surface pattern.

4. The valve according to claim 3, wherein the surface pattern forms a corrugated shape.

5. The valve according to claim 2, wherein the raised and depressed surface portions have a shape which varies periodically along at least one direction of the first surface.

6. The valve according to claim 2, wherein the raised and depressed surface portions have a size which varies periodically along at least one direction of the first surface.

7. The valve according to claim 1, wherein the first electrically conductive layer has a modulus of elasticity being higher than a modulus of elasticity of the film.

8. The valve according to claim 1, wherein the film has a thickness between 90 percent and 110 percent of an average thickness of the film.

9. The valve according to claim 1, wherein the first electrically conductive layer has a thickness which is between 90 percent and 110 percent of an average thickness of the first electrically conductive layer.

10. The valve according to claim 2, wherein the surface pattern comprises waves forming troughs and crests extending in essentially one common direction.

11. The valve according to claim 10, wherein each wave defines a height being a shortest distance between a crest and neighbouring troughs, an average of the heights of the waves is between ⅓ and 20 μm.

12. The valve according to claim 1, wherein the film has an average thickness being between 10 and 200 μm.

13. The valve according to claim 1, wherein the first electrically conductive layer has a thickness in the range of 0.01-0.1 μm.

14. The valve according to claim 2, wherein the second surface is substantially flat.

15. The valve according to claim 1, wherein the laminate comprises a multilayer structure with at least two composites, each composite comprising:
a film made of a dielectric polymer material and having a front surface and a rear surface, the front surface comprising a surface pattern of raised and depressed surface portions, and
a first layer of an electrically conductive material being deposited onto the surface pattern, the electrically conductive layer having a corrugated shape which is formed by the surface pattern of the film.

16. The valve according to claim 15, wherein at least two adjacent composites are arranged with the rear surfaces towards each other.

17. The valve according to claim 15, wherein at least two adjacent composites are arranged with the front surfaces towards each other.

18. The valve according to claim 15, wherein at least two adjacent composites are arranged with the rear surface of one composite towards the front surface of the other composite.

19. The valve according to claim 15, wherein the multilayer structure is made from a number of composites sufficient to achieve an area moment of a cross section for bending of the multilayer structure which is at least 2 times an average of an area moment of inertia of each composite individually.

20. The valve according to claim 15, wherein the surface patterns of each composite are substantially identical.

21. The valve according to claim 1, wherein the first layer is made from metal.

22. The valve according to claim 1, wherein the transducer forms a multilayer structure in which the first and second electrically conductive layers are located adjacently and alternately between layers of the film.

23. The valve according to claim 22, wherein the transducer is formed in such a manner that the laminate, in an unsupported state, fulfils Euler's criteria for stability within a normal operating range for the valve.

24. The valve according to claim 1, wherein the valve comprises a valve element, arranged at least partly in the path to change the path when moved relative to the housing, and the transducer is arranged to move the valve element relative to the housing.

25. The valve according to claim 24, wherein the valve element is shaped to form a ball-valve, a butterfly-valve, a gate-valve, a diaphragm-valve, a rotary-valve, a needle-valve, a pinch-valve, a spool-valve, flapper-nozzle valve or a seat-valve.

26. The valve according to claim 1, wherein transducer is arranged at least partly in the path to change the path upon deformation of the polymer.

27. The valve according to claim 1, wherein the transducer is provided so that the deformation causes a change in volume of the film.

28. The valve according to claim 26, comprising a port through which the path extends, wherein the transducer is arranged to cover the port to a various degree in response to deformation of the polymer.

29. The valve according to claim 1, wherein the laminate is rolled to form an elongated transducer.

30. The valve according to claim 29, wherein the transducer has a cylindrical shape.

31. The valve according to claim 29, wherein the transducer has a tubular shape with an outer surface facing outwardly away from the laminate and an inner surface facing inwardly towards an inner conduit.

32. The valve according to claim 29, wherein the laminate is rolled relative to a surface pattern of at least one of the layers so that the deformation of the film causes radial expansion of the transducer.

33. The valve according to claim 29, wherein the laminate is rolled relative to a surface pattern of at least one of the layers so that the deformation of the film causes axial expansion of the transducer and thus variable distance between axially opposite end faces of the transducer.

34. The valve according to claim 29, wherein the housing comprises a tubular outer element forming a conduit, and an inner element arranged in the conduit, the tubular shaped transducer being arranged between an inner surface of the outer element and an outer surface of the inner element.

35. The valve according to claim 34, wherein an outer surface of the tubular transducer is sealed to the inner surface of the outer element and an inner surface of the tubular transducer is sealed to the outer surface of the inner element.

36. The valve according to claim 31, wherein the inner element is tubular and comprises an inner conduit and at least one passage from at least one opening in the outer surface of the inner element to at least one opening in an inner surface of the inner element, the transducer being arranged to selectively cover at least one of the outer openings and uncover the at least one outer opening by deformation of the film.

37. The valve according to claim 34, wherein the transducer constitutes at least a part of the inner element.

38. The valve according to claim 33, wherein the path comprises a seat which cooperates with a sealing one of the end faces to open or close a passage across the seat by deformation of the polymer.

39. The valve according to claim 38, wherein the sealing end face comprises a sealing member of a resilient material.

40. The valve according to claim 1, further comprising a control system in communication with the first and second layers of an electrically conductive material and being adapted to provide a ratio between a desired flow condition in the path and an electrical signal applied to the first and second layers.

41. The valve according to claim 40, wherein the control system is adapted to provide a ratio between a flow condition in the path and an electrical signal measurable on the first and second layers.

42. The valve according to claim 40, wherein the control system is adapted to store a transformation rule which determines a ratio between flow resistance and voltage between the first and second layers.

43. The valve according to claim 40, wherein the control system is adapted to store a transformation rule which determines a ratio between a pressure of a fluid in the passage and capacitance between the first and second layers.

44. The valve according to claim 40, wherein the control system is adapted control an electrical field applied between the layers based on a sensed temperature.

45. The valve according to claim 40, wherein the control system is adapted to determine a flow condition in the path based on capacitance between the first and second layers of electrically conductive material.

46. A system for thermal conduction comprising a source of a thermally conductive fluid, a recipient for the fluid and at least one valve according to claim 1, wherein the layers are connected to an electrical source which is controlled by control means which provides an electrical field based on a sensed temperature.
